(19) United States
(12) Patent Application Publication
(10) Pub. No.: US 2026/0284632 A1
(43) Pub. Date: Sep. 24, 2026

(54) STRUCTURALLY REINFORCED AND NESTED PACKING ELEMENTS

(71) Applicant: EXXONMOBIL TECHNOLOGY AND ENGINEERING COMPANY, Spring, TX (US)

(72) Inventors: Kendall S. Fruchey, Humble, TX (US); James F. COLWELL, Houston, TX (US); Justin A. FEDERICI, Doylestown, PA (US); Michael L. HERGENROTHER, Kingwood, TX (US)

(21) Appl. No.: 19/562,483

(22) Filed: Mar. 10, 2026

Related U.S. Application Data
(60) Provisional application No. 63/774,971, filed on Mar. 20, 2025.

(51) Int. Cl. B01J 19/32; B01D 3/10

(52) U.S. Cl. CPC B01J 19/32; B01D 3/10; B01J 2219/3221; B01J 2219/32213; B01J 2219/32227; B01J 2219/32483; B01J 2219/3306

(57) ABSTRACT

A container is disclosed that includes a body defining a first lip, a second lip, and a third lip. A first compartment is defined between the first and second lips and a second compartment is defined between the second and third lips. The first compartment is to receive a first packing layer and the second compartment is to receive a second packing layer.

### BACKGROUND

The present disclosure relates to columns in which mass transfer and heat exchange occur and, more particularly, to structured packing modules that are used in mass transfer columns.

Mass transfer columns are used to contact at least two fluid streams to provide product streams of specific composition and/or temperature. Some mass transfer columns, such as those utilized in multicomponent distillation and absorption applications, contact a gas-phase stream with a liquid-phase stream, while others, such as extraction columns, may be designed to facilitate contact between two liquid phases of different densities. Oftentimes, mass transfer columns contact an ascending vapor or liquid stream with a descending liquid stream, usually along multiple mass transfer surfaces disposed within the column. Commonly, these transfer surfaces are defined by structures placed in the interior volume of the column that are configured to facilitate intimate contact between the two fluid phases. Because of these transfer surfaces, the rate and/or degree of mass and heat transferred between the two phases is enhanced.

Structured packing layers are commonly used to provide heat and/or mass transfer surfaces within a column. The size of a structured packing layer is generally limited by weight and mechanical integrity thereof. As such, packing a mass transfer column may require a large number of packing layers, which can be laborious and time consuming for workers to load into the mass transfer column. Furthermore, a structured packing layer is generally very open, with a void fraction of about 97% or greater. This results in large volumes of packing, which are difficult to ship and results in high shipping and transportation costs.

Accordingly, systems and methods for reducing the time and effort associated with loading a mass transfer column with structured packing layers, as well reducing the size of the packing layers during transportation, are desired.

### SUMMARY

In some aspects, a mass transfer column is provided. The mass transfer column includes a volume for receiving packing material. The mass transfer column further includes at least one container within the volume for receiving packing material, the at least one container having a first lip; a second lip, wherein a first compartment is defined between the first and second lips; and a third lip, wherein a second compartment is defined between the second and third lips. The mass transfer column further includes a first packing layer within the first compartment, the first packing layer comprising a first polymer. Additionally, the mass transfer column includes a second packing layer within the second compartment, the second packing layer comprising a second polymer, the at least one container being composed of a material different from the first polymer and the second polymer.

In other aspects, a method for contacting a vapor phase and a liquid phase in such a mass transfer column is provided. The method includes contacting a vapor phase with a liquid phase in the volume containing the first packing layer and the second packing layer. Optionally, the contacting comprises a vapor loading of 0.09 m/s or higher.

In still other aspects, a method for loading a packing layer into such a mass transfer vessel is provided. The method includes loading a plurality of packing sheets into the at least one container, the packing sheets being supported by at least one lip of the at least one container. Additionally, the method includes loading the at least one container into a mass transfer vessel, the at least one container substantially occupying a cross-section of an interior of the mass transfer vessel.

In yet other aspects, a structured packing layer is provided. The structure packing layer includes a plurality of structured packing sheets that are movable relative to one another to transition the packing layer between: a deployed state in which the packing layer exhibits a first volume; and a compact state in which the structured packing layer exhibits a second volume less than the first volume.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a perspective view of an example mass transfer column in which a portion of a shell of the column is broken away to show structured packing layers therein.

FIG. 2 illustrates a structured packing module of a structured packing layer of FIG. 1 that includes a plurality of structured packing sheets.

FIG. 3 illustrates a container for housing one or more packing layers of FIG. 1, in accordance with at least one aspect of the present disclosure.

FIG. 4 is a side, cross-sectional view of the container of FIG. 3 loaded with structured packing layers and loaded into the mass transfer column of FIG. 1, in accordance with at least one aspect of the present disclosure.

FIG. 5 is a packing layer in a deployed state, in accordance with at least one aspect of the present disclosure.

FIG. 6 is the packing layer of FIG. 5 in a compact state, in accordance with at least one aspect of the present disclosure.

### DETAILED DESCRIPTION

The present disclosure relates to columns in which mass transfer and heat exchange occur and, more particularly, to structured packing modules that are used in mass transfer columns.

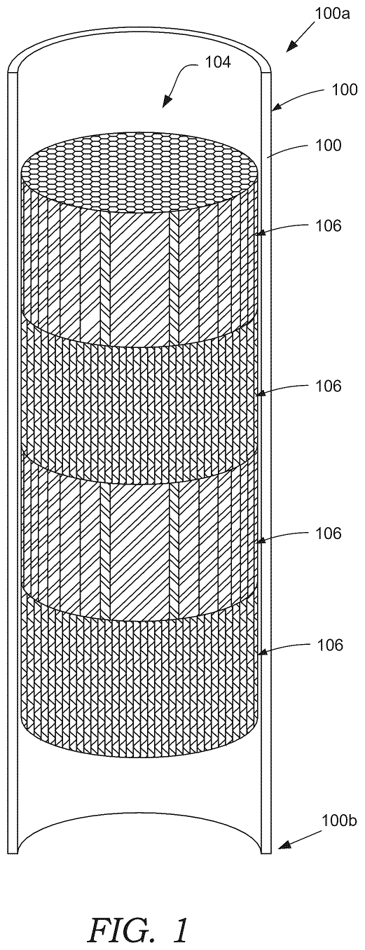

FIG. 1 illustrates an example mass transfer column 100 for use in mass transfer or heat exchange processes. The mass transfer column 100 may include an upright, external shell 102 that may be cylindrical or polygonal, such as triangular or rectangular. The shell 102 may be constructed from one or more rigid materials that are inert to, or are otherwise compatible with, fluids and conditions present during operation of the mass transfer column 100.

The mass transfer column 100 may be used for processing fluid streams, typically liquid or vapor streams, to obtain fractionation products or to otherwise cause mass transfer or heat exchange between the fluid streams. For example, the mass transfer column 100 may be one in which crude atmospheric, lube vacuum, crude vacuum, fluid or thermal cracking fractionating, coker or visbreaker fractionating, coke scrubbing, reactor off-gas scrubbing, gas quenching, edible oil deodorization, pollution control scrubbing, absorption of CO₂ from flue gas using a solvent, or other processes occur.

The shell 102 of the mass transfer column 100 may define an open, internal region or recess 104 in which the desired mass transfer or heat exchange between the fluid streams may occur. The fluid streams may comprise one or more ascending vapor streams and one or more descending liquid streams.

One or more fluid streams may be directed into the recess 104 of the mass transfer column 100 through any number of feed lines (not shown) positioned at locations along the height of the mass transfer column 100. For instance, liquid may be introduced through a feed line at an upper end 100a of the mass transfer column 100, descend through the mass transfer column 100, and be removed at a location below the upper end 100a of the mass transfer column 100, while vapor may be introduced through a feed line at a lower end 100b of the mass transfer column 100, ascend through the mass transfer column 100, and be removed at a location above the lower end 100b of the mass transfer column 100. The vapor streams may be generated within the mass transfer column 100 rather than being introduced into the mass transfer column 100 through a feed line. Fluid streams may be directed out of the mass transfer column 100 through one or more takeoff lines.

The mass transfer column 100 may include one or more structured packing layers 106 positioned within the open internal region 104. As illustrated, four packing layers 106 may be provided in a stacked relationship, but more (e.g. five, six, or seven) or fewer (e.g. one, two, or three) than four packing layers 106 may be provided. Each of the structured packing layers 106 may extend across the horizontal, internal cross section of the column 100 and may be suitably supported. In a typical conventional configuration, packing layers typically sit directly on top of an underlying packing layer 106. In other aspects, the packing layers can be supported on a suitable support, such as a support extending from the shell 102. As an example, a suitable support can correspond to a mesh or other separate support surface that provides support for a packing layer 106 while having sufficient open area to have a reduced or minimized impact on fluid flow. Such a mesh or open support structure can substantially extend across the cross-section of the open internal region 104. As another example, a lip or other support extending from shell 102 can support a packing layer. In some aspects, a support extending from shell 102 can be used in conjunction with a mesh or other open support structure that extends across the cross-section of the open internal region 104.

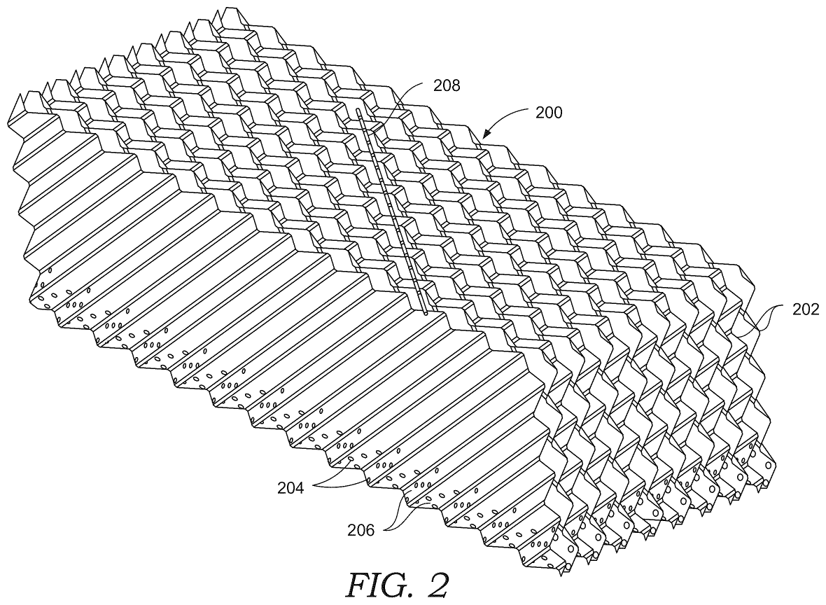

With reference now to FIGS. 1 and 2, each packing layer 106 may be formed by a plurality of structured packing modules 200 that are formed from a plurality of individual structured packing sheets 202. The structured packing sheets 202 in each structured packing module 200 may be positioned in an upright, parallel relationship to each other. Each of the structured packing sheets 202 may be constructed from a rigid, or substantially rigid, material, such as a metal, polymer, or ceramic, having sufficient strength and thickness to withstand conditions experienced within the column 100. Each of the structured packing sheets 202 may be smooth and free of surface texturing or, alternatively, may include various types of texturing, embossing, grooves, or dimples, or combinations thereof. The structured packing sheets 202 may be perforated with apertures 204 that allow fluid to pass through the individual structured packing sheets 202. The apertures 204 are shown only in some portions of the structured packing sheets 202 in FIG. 2 for illustration purposes, but may be defined in all, or substantially, all regions of the structured packing sheets 202.

Each structured packing sheet 202 may be corrugated with a plurality of parallel corrugations 206 that extend along a portion, or all, of the associated packing sheet 202. The corrugations 206 may be generally triangular or sinusoidal and may be formed of alternating peaks and valleys and corrugation sidewalls that extend between the peaks and valleys. As illustrated, adjacent structured packing sheets 202 may have corrugations 206 in contact with each other. Alternatively, some, or all, of the corrugations 206 in one of the structured packing sheet 202 may be spaced from the corrugations 206 in an adjacent structured packing sheet 20, such with one or more spacers.

Each structured packing layer 106 formed by the structured packing modules 200 may normally be stacked directly on the adjacent underlying structured packing layer 106 and may typically be rotated relative to the adjacent packing layer(s) 106 so that the individual structured packing sheets 202 in one of the packing layers 106 are rotated to form an angle with respect to the vertical planes defined by the individual packing sheets 202 in the adjacent structured packing layer(s) 106. The angle of rotation may be about 45 to about 90 degrees. The overall height of each packing layer 106 may range from about 2 inches to about 36 inches, such as 6 inches, 12 inches, 18 inches, 24 inches, or 30 inches, as examples. The individual structured packing sheets 202 may be welded together, such as with spot welds at contacting corrugations, or by fasteners 208 that extend into the structured packing sheets 202 from the opposite sides of the structured packing module 200, or a combination thereof.

Referring again to FIG. 1, the size of a packing layer 106 is generally limited by weight and mechanical integrity thereof. As such, packing the mass transfer column 100 may require a large number of packing layers 106, which can be laborious and time consuming for workers to load into the mass transfer column 100. Accordingly, systems and methods for reducing the time and effort associated with loading a mass transfer column 100 with packing layers 106 are desired.

In various aspects, one way to overcome the time and effort associated with loading a mass transfer column with packing layers is to use modular containers that can contain a large plurality of packing sheets. One or more modular containers can be assembled separately from the mass transfer column. The modular containers containing packing sheets can then be inserted into the mass transfer column. Thus, rather than individually loading packing sheets to form a packing layer, a modular container containing packing sheets can be pre-assembled and then loaded as a pre-assembled module into the mass transfer column. Using plastic packing sheets for the packing layers can reduce or minimize the weight of a modular container, thus facilitating pre-assembly of the modular container while still allowing the module to be light enough for transport and loading into the mass transfer column.

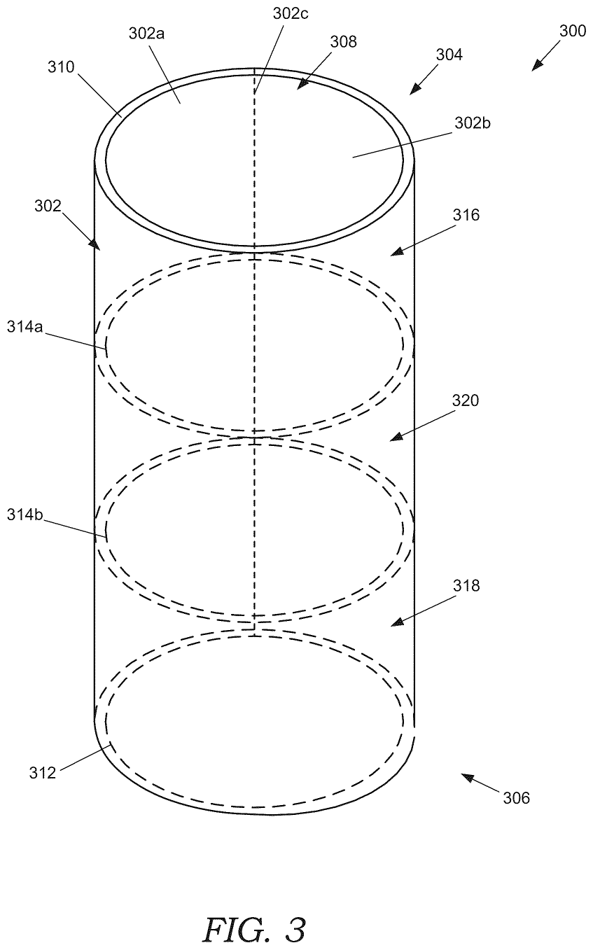

An example of using a modular container to load a plurality of packing sheets as part of a module is shown in FIG. 3. FIG. 3 illustrates a container 300 for housing one or more packing layers 106 (FIG. 1), in accordance with at least one aspect of the present disclosure. The container 300 may include a body 302 to be received within the recess 104 (FIG. 1) of the mass transfer column 100 (FIG. 1). As illustrated, the body 302 may have a circular cross-section to be received within the circular mass transfer column 100 of FIG. 1. Alternatively, the container 300 may have a polygonal cross-section to be received within a polygonal mass transfer column. The cross-sectional profile of the column may be a similar, or substantially similar, in shape and size to the cross-sectional profile of the mass transfer column 100 (FIG. 1) such that the container 300 can be received within the mass transfer column 100 (FIG. 1) and define no, or substantially no, radial gaps therebetween. In other aspects, a plurality of containers 300 may be used to fill the volume of a packing layer. In such aspects, the plurality of bodies can be assembled together to substantially fill the cross-sectional profile of the mass transfer column within a given layer. In aspects where a plurality of containers are used to fill the cross section, each container can include one or more lips as well as associated meshes or grids to assist with maintaining a plurality of plastic sheets within the body.

The body 302 may include a first or “upper” end 304 and a second or “lower” end 306 opposite the first end 304 and define a channel 308 that extends from the first end 304 to the second end 306. The body 302 may further define a first, or “upper” lip 310 at the first end 304, a second, or “lower” lip 312 (shown in phantom) at the second end 306, and third or “intermediate” lips 314a, 314b (shown in phantom) within the channel 308 at locations between the first and second ends 304, 306. Each lip 310, 312, 314a,b may extend into the channel 308. While two intermediate lips 314a,b are shown and described, the body 302 may define less than two intermediate lips (e.g. one intermediate lip) or more than two intermediate lips (e.g. three, four, or five intermediate lips). In some aspects, a mesh, grid, or other open support structure (not shown) may span the remaining portion of the cross-sectional area at the level of the upper lip, at the level of the lower lip, and/or at the level of one or more of the intermediate lips, up to having a mesh, grid, or other open support structure associated with each lip of the body 302.

A first or “upper” compartment 316 may be defined within the channel 308 between the first lip 310 and the third lip 314a, a second or “lower” compartment 318 may be defined within the channel 308 between the second lip 312 and the third lip 314b, and a third or “intermediate” compartment 320 may be defined within the channel 308 between the third lips 314a,b. While one intermediate compartment 320 is shown and described, the body 302 may define more than one intermediate compartment 320, such as two, three, or four intermediate compartments. The number of intermediate compartments 320 may be one less than the number of intermediate lips 312 defined by the body 302. For example, the body 302 may define three intermediate lips and, therefore, may define two intermediate compartments with each intermediate compartment defined between a pair of intermediate lips.

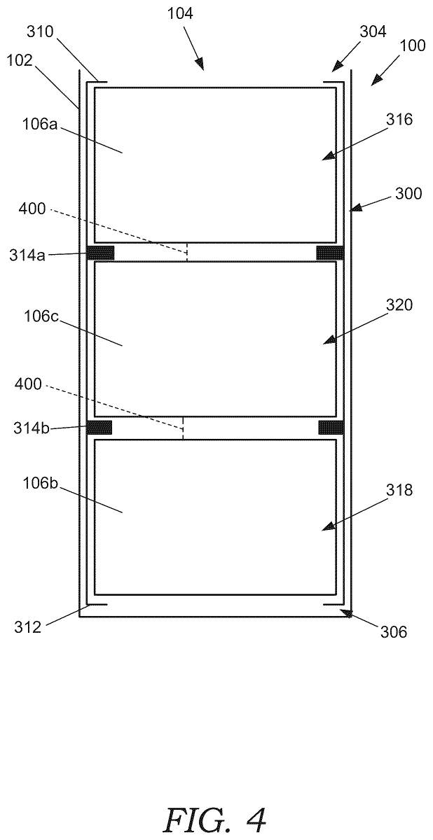

The upper, lower, and intermediate compartments 316, 318, 320 may each be sized to receive a packing layer 106 therein. With reference now to FIG. 4, the upper compartment 316 may receive a first packing layer 106a, the lower compartment 318 may receive a second packing layer 106b, and the intermediate compartment 320 may receive a third packing layer 320. The first and third lips 310, 314a may longitudinally restrain the first packing layer 106a in the first compartment 316, the second and third lips 312, 314b may longitudinally restrain the second packing layer 106b in the second compartment 318, and the third lips 314a,b may longitudinally restrain the third packing layer 106c in the third compartment 320. Accordingly, the lips 310, 312, 314a,b may co-operatively maintain a longitudinal position of the first, second, and third packing layers 106a-c, such as during mass transfer within the mass transfer column 100.

With reference again to FIG. 3, the body 302 may include a first body portion or “first shell” 302a and a second body portion or “second shell” 302b rotatably coupled to the first body portion 302a, such as with a hinge 302c, to allow the body 302 to transition between a closed configuration (FIG. 3) and an open configuration (not shown). Accordingly, a user may transition the body 302 to the open configuration to load (position) the packing layers 106a-c within the compartments 316, 318, 320 and then may transition the body 302 to the closed configuration to enclose the packing layers 106a-c within the body 302. The container 300 may include a lock (not shown) which may maintain the body 302 in the closed configuration. In aspects where the body 302 includes multiple body portions, if a grid, mesh, or other open support structure is associated with at least one lip, the open support structure can move in any convenient manner when the body portions are moved into a load position. For example, in a configuration such as FIG. 3, where body 302 includes first portion 302a and second portion 302b, one option is to have a first half of the open support structure attached to and move with first portion 302a, while a second portion of the open support structure is attached to and moves with second portion 302b.

The inventors have found that a vertical gap between packing layers 106 reduces liquid holdup and, therefore, pressure drop, along the packing layers 106. Accordingly, as shown in FIG. 4, the upper and lower lips 310, 312 may be a first thickness and the intermediate lips 314a,b may be a second thickness greater than the first thickness. The second thickness may vertically offset adjacent packing layers (e.g. the first packing layer 106a from the third packing layer 106c) by a gap 400 to reduce pressure drop therebetween. The gap 400 may be about 0.5 inches to about 1 inch. More generally, the gap 400 may be 0.5 inches (~1.3 cm) to 3.0 inches (~7.6 cm), or 0.5 inches (~1.3 cm) to 2.0 inches (~5.1 cm), or 0.5 inches (~1.3 cm) to 1.0 inches (~2.5 cm), or 1.0 inches (~2.5 cm) to 3.0 inches (~7.6 cm), or 1.0 inches (~2.5 cm) to 2.0 inches (~5.1 cm).

As referenced elsewhere herein, the structured packing sheets 202 (FIG. 2) of the structured packing layers 106 may be constructed from a first material, such as a polymer. The body 302 of the container 300 may be made (constructed) from a second material different than the first material. For instance, the body 302 may be made from metal, such as stainless steel. Accordingly, the container 300 may provide additional structural support to the structured packing layers 106.

Accordingly, the container 300 can be loaded with multiple structured packing layers 106 and then positioned within a mass transfer column 100, therefore significantly reducing the labor and time associated within loading packing layers 106 into a mass transfer column 100 compared to conventional methods, which typically requires loading one structured packing layer 106 into the mass transfer column 100 at a time. The container 300 extends substantially around the peripheries of the packing layers 106, with only the lips 310, 312, 314a,b extending radially along the faces of the packing layers 106 to maintain the longitudinal positions thereof. Accordingly, the container 300 may not, or at least may not substantially, interfere with mass transfer that occurs within the mass transfer column 100.

Referring again to FIG. 1, a packing layer 106 is generally very open, with a void fraction of about 97% or greater. This results in large volumes of packing, which are difficult to ship and results in high shipping and transportation costs. Accordingly, systems and methods for reducing the size of the packing layer 106 during transportation are desirable.

FIG. 5 illustrates a packing layer 500, in accordance with at least one aspect of the present disclosure. The packing layer 500 may be similar to the packing layer 106 and therefore may be best understood with reference thereto.

The packing layer 500 may be formed from a plurality of individual structured packing sheets 502 that may be similar to structured packing sheets 202. For instance, the structured packing sheets 502 may be constructed from a rigid, or substantially rigid, material, such as a metal, polymer, or ceramic, having sufficient strength and thickness to withstand conditions experienced within the mass transfer column 100. In addition, the structured packing sheets 502 may include various types of texturing, embossing, grooves, or dimples, or combinations thereof, and/or may be perforated with apertures, like apertures 204, that allow fluid to pass through the individual structured packing sheets 502. In addition, each structured packing sheet 502 may be corrugated with a plurality of parallel corrugations, like corrugations 206, that extend along a portion, or all, of the associated packing sheet 502.

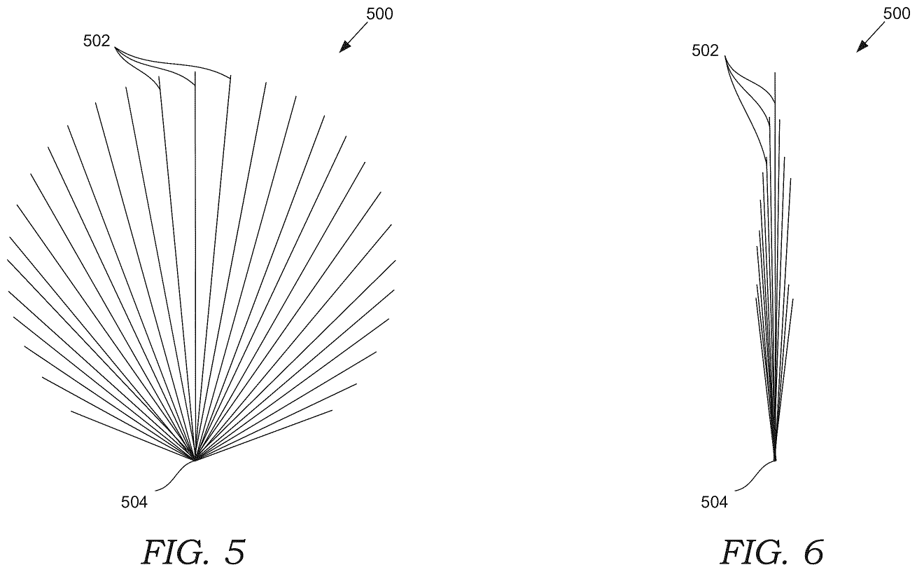

The structured packing sheets 500 may be pivotably coupled together at a pivot 504, thereby allowing the packing layer 500 to be transitioned between a deployed state, as shown in FIG. 5, and a compact state, as shown in FIG. 6. In the deployed state, the packing sheets 502 are spaced apart from one another to allow the packing layer 500 to be positioned in the mass transfer column 100 (FIG. 1) for the purposes of mass transfer, like packing layer 106 (FIG. 1). In the compact state, the packing sheets 502 are spaced closer together compared to the deployed state. In the deployed state, the packing layer 500 exhibits a first volume and, in the compact state, the packing layer 500 exhibits a second volume less than the first volume.

The packing layer 500 may be similar in nature to a Japanese folding fan (sensu fan). For instance, the packing layer 500 may include webs that extend between adjacent structured packing layers 502. The webs may include various types of texturing, embossing, grooves, or dimples, or combinations thereof, and/or may be perforated with apertures, like apertures 204, that allow fluid to pass through the webs.

Accordingly, the packing layer 500 can be transitioned to the compact state during shipping and then transitioned to the deployed state to be positioned in the mass transfer column 100 (FIG. 1).

FIG. 5 and FIG. 6 illustrate one example of a packing layer (or a portion of a packing layer) that can transition between a deployed state having a first larger volume and a compact state having a second, smaller volume. Another type of packing layer configuration that can transition between a deployed state and a compact state is an accordion-style packing layer. For an accordion-style packing layer, either individual packing sheets or pluralities of packing sheets can be transported and carried while in a compact state. In the compact state, such an accordion-style packing sheet (or accordion-style packing sheets) can have a configuration similar to the configuration in FIG. 6, but instead of opening with radial symmetry, the sheet(s) can open laterally to form a structure similar to the sheet(s) shown in FIG. 2, such as a sinusoidal structure. The sinusoidal (or other accordion-like) structure can then be compressed to return the sheet(s) to a compact state.

As an example of loading a mass transfer vessel, packing sheets in a compact or closed state can be introduced into one or more containers. The packing sheets can then be opened or expanded to be in an open or expanded state. In the open or expanded sheet, the packing sheets can be at least partially supported by a lip of the container. The one or more containers can then be loaded into a mass transfer vessel. For example, containers can be lowered into the mass transfer vessel through an opening in the top of the mass transfer vessel. By using containers, packing sheets can be pre-assembled into containers, thus reducing the work to form a packing layer at the site of the mass transfer vessel. One or more containers can then be loaded into a mass transfer vessel. In some aspects, a single layer of containers is present, such as a single layer of containers where each container includes multiple packing layers. In other aspects, a plurality of levels of containers can be present.

### Example of Reduced Interface Holdup by Including Spacer

A series of experimental runs were performed to investigate liquid holdup at the boundary between packing layers in a test apparatus designed to be comparable to a wash zone within a vacuum distillation tower. In the apparatus, liquid loadings of 0.65 gpm/ft² (26.8 lpm/m²) and 1.3 gpm/ft² (53.6 lpm/m²) were tested, where gpm and lpm are gallons per minute and liters per minute, respectively. For each of these liquid loadings, three vapor loadings were tested. The three vapor loadings corresponded to a density-corrected velocity of 0.2 ft/s (0.06 m/s), 0.3 ft/s (0.09 m/s), and 0.4 ft/s (0.12 m/s) were tested. The density-corrected velocity corresponds to C_{f}, which is a parameter often used for characterizing distillation towers. C_{f} is defined as

$${C}_{f} = {v}_{s} \sqrt{\frac{{ρ}_{v}}{{ρ}_{l} - {ρ}_{v}}} \qquad ( 1 )$$

In Equation (1), vₛ is the superficial velocity, ρᵥ is the vapor density, and ρᵥ is the liquid density.

Each combination of liquid loading and vapor loading was used to determine liquid holdup at the interface between two types of commercially available structured packing. Three types of interfaces were used. For the first interface, the structured packing layers were separated only by a mesh grid, resulting in little or no separation between the layers (gap was 0.5 cm or less). The interface holdup measured from these runs was used as a baseline for each combination of vapor loading and liquid loading. For the second interface, a spacer was included, so that a gap of 2.25 inches (~5.7 cm) was present between the structured packing layers. For the third interface, a layer of a packing material with higher open cross-sectional area/lower density was used. This packing material with a high open cross-sectional area/lower density had a thickness of 2.25 inches (~5.7 cm).

In the test system, air was used as the vapor component and water was used as the liquid component. Interface holdup was measured using a low level nuclear source outside of the column containing the packing. A detector was placed on the opposite side of the exterior of the test column. The liquid phase in the column reduces the amount of gamma rays that can be detected on the opposite side of the column relative to the portions of the column where a vapor phase is present.

Table 1 shows results from operating the test system at the six different combinations of vapor loading and liquid loading. Low and high liquid loading refer to 26.8 and 53.6 lpm/m² loadings, while low, medium, and high vapor loading correspond to 0.06, 0.09, and 0.12 m/s. The values in the table correspond to the percentage change in interface holdup relative to the baseline of not having an additional spacer or lower density layer to provide a gap between the structured packing layers. Negative percentage change values correspond to a reduction in the amount of liquid holdup.

TABLE 1
Percentage Change in Interface Holdup

| | Liquid Loading/Vapor Loading | | | | | |
|---|---|---|---|---|---|---|
| | Low/ | Low/ | Low/ | High/ | High/ | High/ |
| | Low | Middle | High | Low | Medium | High |
| Spacer | 29.7% | −9.6% | −7.4% | 30.8% | 17.1% | −8.4% |
| Lower Density | 21.5% | −32.5% | −48.1% | −1.0% | −18.8% | −25.7% |
| packing | | | | | | |

In Table 1, at low vapor loading rates, interface liquid holdup is the similar or even increased by addition of the spacer. This demonstrates that introduction of a spacer does not provide a reduction in interface liquid holdup at all conditions. However, at low vapor loading rates, interface liquid holdup is of lower concern. By contrast, at the highest rate of vapor loading (0.12 m/s), addition of the spacer provided a roughly 10% reduction in interface liquid holdup. Although larger reductions in interface liquid holdup were provided by using lower density packing material, it is unexpected that a substantial reduction in liquid holdup could be achieved by introduction of a spacer gap (either sufficiently low density packing material or spacer to provide open volume) between consecutive structured packing layers when operating at high vapor loadings.

### Additional Embodiments

Embodiment 1. A mass transfer column, comprising: a volume for receiving packing material; at least one container within the volume for receiving packing material, the at least one container comprising: a first lip; a second lip, wherein a first compartment is defined between the first and second lips; and a third lip, wherein a second compartment is defined between the second and third lips; a first packing layer within the first compartment, the first packing layer comprising a first polymer; and a second packing layer within the second compartment, the second packing layer comprising a second polymer, the at least one container being composed of a material different from the first polymer and the second polymer.

Embodiment 2. The mass transfer column of Embodiment 1, wherein the first and second lip longitudinally restrain the first packing layer within the first compartment; or a combination thereof.

Embodiment 3. The mass transfer column of any of the above embodiments, wherein a plurality of containers are within the volume for receiving packing material, each container of the plurality of containers comprising: a first lip; a second lip, wherein a first compartment is defined between the first and second lips; and a third lip, wherein a second compartment is defined between the second and third lips, wherein each container of the plurality of containers comprises a first packing layer in the first compartment and a second packing layer with in the second compartment.

Embodiment 4. The mass transfer column of any of the above embodiments, wherein the container comprises a plurality of body portions that are rotatably connected together to have at least a first open position and a second closed position.

Embodiment 5. The mass transfer column of any of the above embodiments, wherein the second lip defines a gap of 1.3 cm or more between the first packing layer and the second packing layer; or wherein the gap is 7.6 cm or less, or 2.5 cm or less; or a combination thereof.

Embodiment 6. The mass transfer column of any of the above embodiments, wherein the first packing layer comprises a plurality of structured packing sheets that are movable relative to one another to transition the packing layer between: a deployed state in which first the packing layer exhibits a first volume; and a compact state in which the first packing layer exhibits a second volume less than the first volume.

Embodiment 7. The mass transfer column of Embodiment 6, wherein the plurality of structured packing sheets are pivotably coupled together at a pivot, and where the structured packing sheets are pivotable about the pivot to transition the structured packing layer between the deployed state and compact state; or wherein the plurality of structured packing sheets comprise accordion-style packing sheets.

Embodiment 8. The mass transfer column of any of the above embodiments, wherein the mass transfer column comprises: a plurality of volumes for receiving packing material; one or more containers within each volume of the plurality of volumes, each container of the one or more containers comprising a first lip and a second lip defining a compartment; and a packing layer within each container of the one or more containers.

Embodiment 9. A method for contacting a vapor phase and a liquid phase in a mass transfer column according to any of Embodiments 1 to 8, comprising: contacting a vapor phase with a liquid phase in the volume containing the first packing layer and the second packing layer.

Embodiment 10. The method of Embodiment 9, wherein the contacting comprises a vapor loading of 0.09 m/s or higher.

Embodiment 11. A method for loading a packing layer into a mass transfer vessel according to any of Embodiments 1 to 8, comprising: loading a plurality of packing sheets into the at least one container, the packing sheets being supported by at least one lip of the at least one container; and loading the at least one container into a mass transfer vessel, the at least one container substantially occupying a cross-section of an interior of the mass transfer vessel.

Embodiment 12. The method of Embodiment 11, further comprising loading a second layer of one or more containers into the mass transfer vessel, a spacing between the packing sheets in the one or more containers and the packing sheets in the second layer of one or more containers being 1.3 cm or more.

Embodiment 13. The method of Embodiment 11 or 12, wherein loading a plurality of packing sheets into the at least one container comprises: loading at least one packing sheet in a compact or closed state into the at least one container; and expanding or opening the at least one packing sheet to be in an open or expanded state, the at least one packing sheet being supported by at least one lip of the container in the open or expanded state, the at least one packing sheet comprising at least one accordion-style packing sheet.

Embodiment 14. A structured packing layer, comprising: a plurality of structured packing sheets that are movable relative to one another to transition the packing layer between: a deployed state in which the packing layer exhibits a first volume; and a compact state in which the structured packing layer exhibits a second volume less than the first volume.

Embodiment 15. The structured packing layer of Embodiment 14, wherein the plurality of structured packing sheets are pivotably coupled together at a pivot, and where the structured packing sheets are pivotable about the pivot to transition the structured packing layer between the deployed state and compact state; or wherein the plurality of structured packing sheets comprise accordion-style packing sheets.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A mass transfer column, comprising:
a volume for receiving packing material;
at least one container within the volume for receiving packing material, the at least one container comprising:
a first lip;
a second lip, wherein a first compartment is defined between the first and second lips; and
a third lip, wherein a second compartment is defined between the second and third lips;
a first packing layer within the first compartment, the first packing layer comprising a first polymer; and
a second packing layer within the second compartment, the second packing layer comprising a second polymer,
the at least one container being composed of a material different from the first polymer and the second polymer.

2. The mass transfer column of claim 1, wherein a plurality of containers are within the volume for receiving packing material, each container of the plurality of containers comprising:
a first lip;
a second lip, wherein a first compartment is defined between the first and second lips; and
a third lip, wherein a second compartment is defined between the second and third lips,
wherein each container of the plurality of containers comprises a first packing layer in the first compartment and a second packing layer with in the second compartment.

3. The mass transfer column of claim 1, wherein the container comprises a plurality of body portions that are rotatably connected together to have at least a first open position and a second closed position.

4. The mass transfer column of claim 1, wherein the second lip defines a gap of about 0.5 inches or more between the first packing layer and the second packing layer.

5. The mass transfer column of claim 1, wherein the second lip defines a gap of 0.5 inches to 3.0 inches.

6. The mass transfer column of claim 1, wherein the second lip defines a gap of 0.5 inches to 1.0 inches.

7. The mass transfer column of claim 1, wherein the first and second lip longitudinally restrain the first packing layer within the first compartment.

8. The mass transfer column of claim 1, wherein the first packing layer comprises a plurality of structured packing sheets that are movable relative to one another to transition the packing layer between:
a deployed state in which first the packing layer exhibits a first volume; and
a compact state in which the first packing layer exhibits a second volume less than the first volume.

9. The mass transfer column of claim 8, wherein the plurality of structured packing sheets are pivotably coupled together at a pivot, and where the structured packing sheets are pivotable about the pivot to transition the structured packing layer between the deployed state and compact state.

10. The mass transfer column of claim 8, wherein the plurality of structured packing sheets comprise accordion-style packing sheets.

11. A method for contacting a vapor phase and a liquid phase in a mass transfer column, comprising:
contacting a vapor phase with a liquid phase in a volume comprising a plurality of packing layers, a first packing layer being separated from a second packing layer by a spacer having a spacer height of about 0.5 inches or more.

12. The method of claim 11, wherein the first packing layer comprises a first polymer, or wherein the second packing layer comprises a second polymer, or a combination thereof.

13. The method of claim 11, wherein the contacting comprises a vapor loading of 0.09 m/s or higher.

14. The method of claim 11, wherein the spacer has a spacer height of 0.5 inches to 3.0 inches.

15. The method of claim 11, wherein the spacer comprises a lip in a container for supporting the first packing layer.

16. A method for loading a packing layer into a mass transfer vessel, comprising:
loading a plurality of packing sheets into at least one container, the packing sheets being supported by at least one lip of the at least one container;
loading the at least one container into at least one volume of a mass transfer vessel, the at least one container substantially occupying a cross-section of an interior of the mass transfer vessel.

17. The method of claim 16, wherein the at least one container comprises a plurality of containers, each container of the plurality of containers comprising a first packing layer, a second packing layer, and a lip as a spacer between the first packing layer and the second packing layer.

18. The method of claim 16, further comprising loading a second layer of one or more containers into the mass transfer vessel, a spacing between the packing sheets in the at least one container and the packing sheets in the second layer of one or more containers being 0.5 inches or more.

19. The method of claim 16, wherein loading a plurality of packing sheets into the at least one container comprises:
loading at least one packing sheet in a compact or closed state into the at least one container; and
expanding or opening the at least one packing sheet to be in an open or expanded state, the at least one packing sheet being supported by at least one lip of the at least one container in the open or expanded state.

20. The method of claim 16, wherein the at least one packing sheet comprises at least one accordion-style packing sheet.

21. The mass transfer column of claim 1, wherein the mass transfer column comprises
a plurality of volumes for receiving packing material;
at least one container within each volume of the plurality of volumes, each at least one container comprising a first lip and a second lip defining a compartment; and
a packing layer within each container.

22. The mass transfer column of claim 21, wherein a plurality of containers are within each volume of the plurality of volumes, each container of the plurality of containers comprising a first lip and a second lip defining a compartment, and a packing layer within each container.

23. The mass transfer column of claim 21, wherein a spacing between the packing layer in the at least one container of a first volume and the packing layer in the at least one container of a second volume is 0.5 inches or more.

24. A structured packing layer, comprising:
a plurality of structured packing sheets that are movable relative to one another to transition the packing layer between:
a deployed state in which the packing layer exhibits a first volume; and
a compact state in which the structured packing layer exhibits a second volume less than the first volume.

25. The structured packing layer of claim 24, wherein the plurality of structured packing sheets are pivotably coupled together at a pivot, and where the structured packing sheets are pivotable about the pivot to transition the structured packing layer between the deployed state and compact state; or wherein the plurality of structured packing sheets comprise accordion-style packing sheets.
